(19) United States
(12) Patent Application Publication
(10) Pub. No.: US 2014/0101023 A1
(43) Pub. Date: Apr. 10, 2014

(54) METHOD AND DEVICE FOR PROVIDING STOCK INFORMATION

(71) Applicant: Jung Woong Kim, Gwangmyeong-si (KR)

(72) Inventor: Jung Woong Kim, Gwangmyeong-si (KR)

(21) Appl. No.: 14/122,186

(22) PCT Filed: Apr. 13, 2012
(86) PCT No.: PCT/KR2012/002833

§ 371 Date: Nov. 25, 2013

(30) Foreign Application Priority Data
May 24, 2011 (KR) 10-2011-049201

(51) Int. Cl. G06Q 40/04

(52) U.S. Cl. CPC G06Q 40/04
USPC 705/37

(57) ABSTRACT

Provided are a method and device for providing stock information, the method, which is performed by a stock information providing device being linked with a stock exchange server via a communication network, including: (a) collecting stock quote data for respective securities issues in real time from the stock exchange server; (b) deriving an aggressive purchase quantity and an aggressive sale quantity for each dynamic bid and ask price unit according to a unit of time for the securities issues by using the stock quote data; and (c) displaying the stock trading data including information on the aggressive sale quantity and aggressive purchase quantity for each dynamic bid and ask price unit through a display device, thereby enabling a user to easily recognize short and long term support and resistance levels through dynamic bid and ask prices.

### TECHNICAL FIELD

The present invention relates, in general, to a method and device for providing stock information for easy recognition of trading mentalities of investors by using information provided on aggressive purchases and aggressive sales for each dynamic bid and ask price unit over a unit of time for securities issues.

### BACKGROUND ART

In general, a conventional limit order book for securities issues displays various high and low bid/ask prices based on a current market price, and remaining orders for respective bid and ask prices, the number of orders, and the real time price and amount of stock deal, and also displays an opening price, a high price, a low price, a basis price, an upper limit price, a lower limit price, a total bid amount, a total ask amount, an advance decline ratio for each bid and ask price, a mini chart and the like.

The lists displayed as such may vary depending on an application (Home Trading Service) for executing services, but they are practically the same.

In general, many investors determine their trading with reference to various kinds of information such as the basic analysis and fundamentals of companies, and themes, news, and technical analysis of companies and the like, but finally carry out purchase or sale orders in consideration of the details of trading, support and resistance lines, and the like displayed on the limit order book. The limit order book is systemically important. However, the current limit order book serves only to fragmentarily show the details of trading, so it is problematic in that information obtained by investors from the limit order book is limited to very shortsighted information.

Furthermore, since a representatively well-used minute candle chart displays only an opening price, a low price, a high price and a closing price according to a unit of time, there is a limitation in understanding the power of trading in detail. Thus, in order to compensate the limitation, the investors have mainly used a method of displaying a trading volume chart and a candle chart together so as to check a trading volume for respective candles. However, based on only the candle chart and the trading volume chart, it is technically insufficient to accurately understand the power of support and resistance.

### DISCLOSURE

### Technical Problem

An aspect of the present invention is intended to provide a method and system for providing stock information for easy recognition of long and short term support and resistance levels by providing information on aggressive purchases and aggressive sales for each dynamic bid and ask price unit over a unit of time through analyzing the details of stock trading in real time.

Thus, embodiments of the present invention enable investors to easily analyze the trend of stock quotations and trading points.

### Technical Solution

In accordance with an aspect of the present invention, there are provided a method capable of providing stock information from a device being linked with a stock exchange server to a user terminal, and a recording medium in which a program for carrying out the method is recorded.

According to one embodiment of the present invention, there is provided a method for providing stock information to a user terminal, which is conducted by a stock information providing device being linked with a stock exchange server via a communication network, the method including: (a) collecting stock quote data for respective securities issues in real time from the stock exchange server; (b) deriving an aggressive purchase quantity and an aggressive sale quantity for each dynamic bid and ask price unit according to a unit of time for the securities issues by using the stock quote data; and (c) displaying the stock trading data including information on the aggressive sale quantity and aggressive purchase quantity for each dynamic bid and ask price unit through a display device, thereby enabling a user to easily recognize short and long term support and resistance levels through dynamic bid and ask price units.

In step (b) above, the aggressive sale quantity and the aggressive purchase quantity for each dynamic bid and ask price unit may be derived using the best ask price, the best bid price and a current market price for the respective securities issues, and an entire trading volume for the respective bid and ask price units.

The aggressive sale quantity may show a selling order amount concluded at the best bid price, and the aggressive purchase quantity may show a buying order amount concluded at the best ask price.

In step (b) above, a net aggressive purchase quantity may be further derived using the aggressive sale quantity and the aggressive purchase quantity for each dynamic bid and ask price unit, and in step (c) above, the stock trading data may further include information on the net aggressive purchase quantity.

The net aggressive purchase quantity may be calculated by balancing the aggressive sale quantity and the aggressive purchase quantity for each dynamic bid and ask price unit.

The user terminal may display the stock trading data in a visual information form using at least one of a chart and a table in which the stock trading data are converted by being linked with a unit of time according to the dynamic bid and ask prices.

The dynamic bid and ask price unit may be a multiple of the lowest bid and ask price unit.

In accordance with another aspect of the present invention, there is provided a device linked with a stock exchange server to provide stock information to a user terminal.

According to another embodiment of the present invention, the stock information providing device for providing stock information to the user terminal may include: a collection unit linked with a stock exchange server via a communication network to collect stock quote data for respective securities issues in real time and record the data in a database; a calculation unit for calculating at least one of an aggressive sale quantity and an aggressive purchase quantity for respective dynamic bid and ask price units over a unit of time for the securities issues using the stock quote data; and (c) an information providing unit for converting stock trading data including information on the aggressive sale quantity and the aggressive purchase quantity for the respective dynamic bid and ask price units into a visual information form and controlling the data to be displayed through a display device, thereby enabling a user to easily recognize short and long term support and resistance levels through dynamic bid and ask prices.

The calculation unit may calculate at least one of the aggressive sale quantity and the aggressive purchase quantity for the respective dynamic bid and ask price units using the best ask price, the best bid price and a current market price for the respective securities issues, and an entire trading volume for the respective bid and ask price units.

The calculation unit may further calculate a net aggressive purchase quantity using the aggressive sale quantity and the aggressive purchase quantity for the respective dynamic bid and ask price units, and the information providing unit may provide the stock trading data to the user terminal by further including information on the net aggressive purchase quantity in the stock trading data.

### Advantageous Effects

According to the method and device for providing stock information in accordance with the embodiments of the present invention, the information on aggressive purchases and aggressive sales for the respective dynamic bid and ask price units according to a unit of time is provided through analyzing the details of stock trading in real time, so short and long term support and resistance levels can be easily understood by dynamic bid and ask prices.

Thus, the embodiments of the present invention enable investors to easily analyze the trend of stock quotations and trading points.

### DESCRIPTION OF DRAWINGS

FIG. 1 is a block diagram schematically illustrating a system for providing stock information according to one embodiment of the present invention;

FIG. 2 is a block diagram schematically illustrating an internal configuration of a stock information providing server according to the embodiment of the present invention;

FIG. 3 is an exemplary view in which stock trading data is displayed in a visual information form according to the embodiment of the present invention;

FIG. 4 is a block diagram schematically illustrating an internal configuration of a user terminal according to the embodiment of the present invention;

FIG. 5 is a flowchart showing a method for providing stock information to a user terminal, which is conducted by a stock information providing server, according to another embodiment of the present invention;

FIG. 6 is a view illustrating a monitor on which a price level and a candle chart and a price level for respective bid and ask price units are displayed in a state of being linked with each other; and

FIG. 7 is a view showing an example of displaying an aggressive sale quantity and an aggressive purchase quantity at regular intervals according to the other embodiment of the present invention.

### MODE FOR INVENTION

Embodiments of the present invention are capable of various modifications and alternative forms, and are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of example embodiments. In the following description, it is to be noted that, when the functions of conventional elements and the detailed description of elements related with the present invention may make the gist of the present invention unclear, a detailed description of those elements will be omitted.

Terms such as a first term and a second term may be used for explaining various constitutive elements, but the constitutive elements should not be limited to these terms. These terms is used only for the purpose for distinguishing a constitutive element from other constitutive element.

The terminology used herein is for the purpose of describing particular embodiments only and is not intended to be limiting of embodiments. As used herein, the singular forms are intended to include the plural forms as well, unless the context clearly indicates otherwise. It will be further understood that the terms “comprises,” “comprising,”, “includes,” “including,” “has,” and/or “having” when used herein, specify the presence of stated features, integers, steps, operations, elements, components and/or groups thereof, but do not preclude the presence or addition of one or more other features, integers, steps, operations, elements, components, and/or groups thereof.

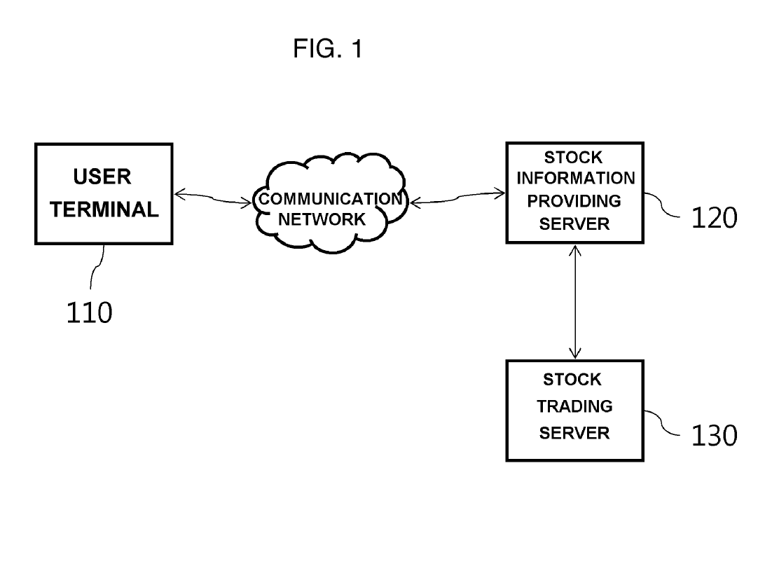

Hereinafter, the embodiments of the present invention will be described in detail with reference to the accompanying drawings.

[The Description of FIG. 1]

FIG. 1 is a block diagram schematically illustrating a system for providing stock information according to one exemplary embodiment of the present invention.

Referring to FIG. 1, the system for providing stock information includes: a user terminal 110; a stock information providing server 120; and a stock exchange server 130.

The user terminal 110 is a device configured to receive a stock information service provided from the stock information providing server 120 via a communication network.

In general, the method including installing an application for home trading in the user terminal 110, receiving information on the current stock trading situations provided from the stock exchange server (not drawn), providing respective stock trading services in real time through the relevant application, and displaying the information in a visual information form is obvious to those having ordinary skill in the art.

Accordingly, the description regarding the general method of displaying the information on the current stock trading situations through the user terminal 110 will be omitted in this specification. Only matters which are needed for explaining major points according to embodiments of the present invention will be described separately.

In accordance with one embodiment of the present invention, the user terminal 110 may display stock trading data including information on an aggressive sale quantity and an aggressive purchase quantity for respective dynamic bid and ask prices over a unit of time for securities issues provided from the stock information providing server 120 in real time in a visual information form. At this time, the unit of time may be a tick, second, minute, time, day, month or year unit.

In this specification, the term “aggressive sale” means a case in which a selling order is conducted at the highest bid price (hereinafter referred to as “the best bid price”). Accordingly, the term “aggressive sale quantity” means a selling order amount concluded at the best bidding price.

Also, the term “aggressive purchase” means a case in which a buying order is conducted at the lowest ask price (hereinafter referred to as “the best ask price”). Accordingly, the term “aggressive purchase quantity” means a buying order amount concluded at the best ask price.

In accordance with another embodiment of the present invention, the user terminal 110 may derive information on an aggressive purchase quantity and an aggressive sale quantity for dynamic bid and ask price units over a unit of time for securities issues by using stock trading data provided from the stock information providing server 120, and may display the information in a visual information form.

The methods of deriving the aggressive purchase quantity and the aggressive sale quantity is carried out by the user terminal 110 or the stock information providing device 120 to be identical to each other. Thus, the description thereof will be conducted upon describing functions of the stock information providing device 120.

The user terminal 110 may be, for example, a computer, a notebook computer, a mobile communication terminal, a smart phone, a tablet PC and the like. That is, if a device has a communication function or can display stock information in a visual information form through a separate communication module, the device can be applied as the user terminal 110 such as those described above.

Also, although it is not separately described in this specification, the user terminal 110 may include a separate application installed to display aggressive sale information and aggressive purchase information provided from the stock information server 120 in a visual information form.

The stock information providing server 120 serves to collect stock quote data from the stock exchange server 130 in real time, to derive information on an aggressive purchase quantity and an aggressive sale quantity for each dynamic bid and ask price unit regarding respective securities issues by using the collected stock quote data, to generate stock trading data including the information and to provide it to the user terminal 110.

Here, the stock trading data may include at least one of real time trading data for respective securities issues, real time stock quote data, and information on an aggressive sale quantity and an aggressive purchase quantity for each relevant bid and ask price unit.

In order to provide convenience of understanding and description, the method of deriving the aggressive sale quantity and the aggressive purchase quantity for respective dynamic bid and ask price units over the unit of time will be described with reference to Table 1 and Table 4 below.

First, as exemplified in a fourth column to a sixth column of Table 1, the method will be described on the assumption that stock quote data and trading data are provided in real time.

In order to provide the convenience of understanding and description, Table 1 describes an example of partial trading data without being limited to stock quote data for a special issue. However, it should be understood that the data is derived according to special securities issues resulting from stock trading, and special issues of futures or options, respectively.

Also, Table 1 described below shows data exemplified for the convenience of understanding and description, and units of a current price, the best ask price, and the best bid price may naturally vary.

TABLE 1

| | Amount | | | | |
|---|---|---|---|---|---|
| | of | Total | | Current | |
| | stock | Trading | Best Ask | Market | Best Bid |
| No. | deal | Volume | Price | Price | Price |
| 1 | −10 | 10 | 17510 | 17505 | 17505 |
| 2 | +15 | 25 | 17510 | 17510 | 17505 |
| 3 | +5 | 30 | 17515 | 17515 | 17510 |

The best ask price, the current price, and the best bid price of Table 1 show stock quote data of F-KOSPI 200, and decimal points thereof are omitted to provide the convenience of understanding and description.

In the case of a first line, it is assumed that there is no previous trading volume, the current market price of a relevant viewpoint is 17505, the best ask price is 17510, and the best bid price is 17505. In the case of the first line, since the current price and the best bid price are identical to each other, it can be understood that aggressive sale occurs.

That is, the total trading volume of 10 on the first line means occurrence of the aggressive sale quantity of 10. In order to provide the convenience of understanding and description, aggressive selling is indicated by “−,” and aggressive buying is indicated by “+.”

In this specification, the total trading volume represents a total trading volume in which a trading volume for each bid and ask price unit is accumulated.

Accordingly, the total trading volume on a second line means a value in which the total trading volume of the first line and the trading volume generated at the second line are accumulated. Thus, the real trading volume (i.e. the amount of stock deal) for each bid and ask price unit on the second line means a value in which the total trading volume of the first line is deducted from the total trading volume of the second line. That is, it can be seen that the amount of stock deal on the second line becomes 15. In the case of the second line, since the current market price and the best asking price are identical to each other, it can be understood that aggressive purchase occurs. At this time, the aggressive purchase quantity becomes 15.

Referring to a third line, since the best ask price and the current market price are identical to each other, it can be understood that aggressive purchase occurs. The aggressive purchase quantity becomes 5.

Table 2 below shows one example for displaying an aggressive purchase quantity and an aggressive sale quantity.

TABLE 2

| Aggressive | | Net Aggressive | |
|---|---|---|---|
| Purchase | Aggressive | Purchase | Bid and ask |
| Quantity | Sale Quantity | Quantity | price unit |
| | | | 17515 |
| 15 | | +5 | 17510 |
| | 10 | | 17505 |
| | | | 17500 |

As described in Table 1, the aggressive purchase quantity generated at 17510 is 15, and the aggressive sale quantity generated at 17505 is 10. These quantities are indicated as shown in Table 2 above, respectively.

The net aggressive purchase quantity may be derived from deducting the aggressive purchase quantity concluded at the ask price from the aggressive sale quantity concluded at the bid price corresponding thereto. Of course, the net aggressive purchase quantity may be derived from deducting the aggressive sale quantity concluded at the bid price from the aggressive purchase quantity concluded at the ask price corresponding thereto.

As such, the net aggressive purchase quantity may represent a trading volume deducted according to the bid price in comparison with the ask price (or the ask price in comparison with the bid price).

Thus, Table 2 may show the net aggressive purchase quantity as Table 3 below.

TABLE 3

| Aggressive | | Net Aggressive | |
|---|---|---|---|
| Purchase | Aggressive Sale | Purchase | Bid and ask |
| Quantity | Quantity | Quantity | price unit |
| | | | 17515 |
| 15 | | | 17510 |
| | 10 | −5 | 17505 |
| | | | 17500 |

The stock information providing server 120 may show a bid and ask price unit in the unit of one tick as shown in Table 2 and Table 3, or may show the bid and ask price unit by integrating it into a multiple of one tick.

Table 4 below shows an example in which the aggressive sale quantity, the aggressive purchase quantity and the net aggressive purchase quantity are integrated into dynamic bid and ask price units.

In this specification, the dynamic bid and ask price unit may be a unit in which bid and ask prices are grouped into a value designated by the user (for example, a background of the bid and ask price unit) or a predetermined value (for example, a multiple of the bid and ask price unit), and may be, for example, a multiple of the lowest bid and ask price unit.

In order to provide the convenience of understanding and description, Table 4 exemplifies a case in which the dynamic bid and ask price unit is 20 times of one tick (i.e., 1P).

TABLE 4

| Aggressive | | Net Aggressive | |
|---|---|---|---|
| Purchase | Aggressive Sale | Purchase | Bid and ask |
| Quantity | Quantity | Quantity | price unit |
| | | | 17800 |
| 1250 | 1000 | +250 | 17700 |
| 1100 | 1050 | +50 | 17600 |
| | | | 17500 |

As described above, the stock information providing service 120 may derive at least one of information on an aggressive purchase quantity, an aggressive sale quantity and a net aggressive purchase quantity for each dynamic bid and ask price unit over a time unit for respective securities issues by using the stock quote data received from the stock exchange server 130 in real time, and may generate stock trading data including at least one of information on the aggressive purchase quantity, the aggressive sale quantity and the net aggressive purchase quantity, thereby transmitting the data to the user terminal 110.

Also, in this specification, it is assumed that the stock information providing server derives at least one of information on the aggressive sale quantity, the aggressive purchase quantity and the net aggressive purchase quantity for each dynamic bid and ask price unit regarding respective securities issues, and generates the stock trading data including at least one of information on the aggressive sale quantity, the aggressive purchase quantity and the net aggressive purchase quantity. However, the derivation and generation may be conducted through an application installed in the user terminal 110.

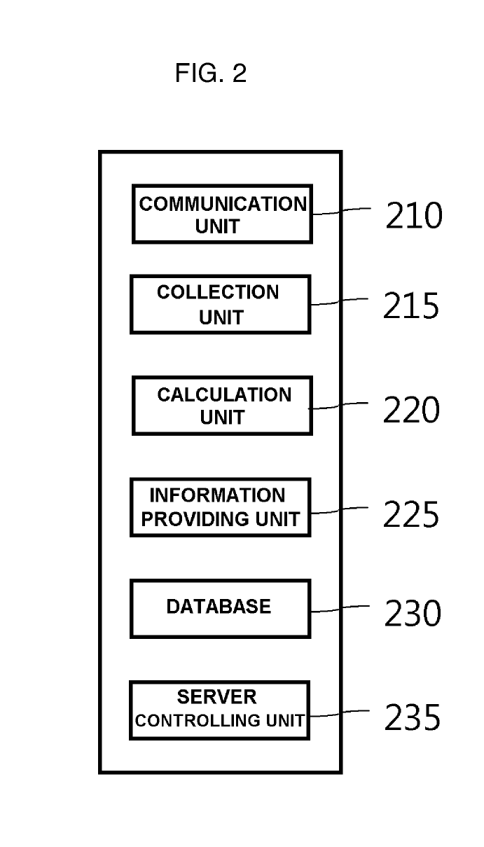

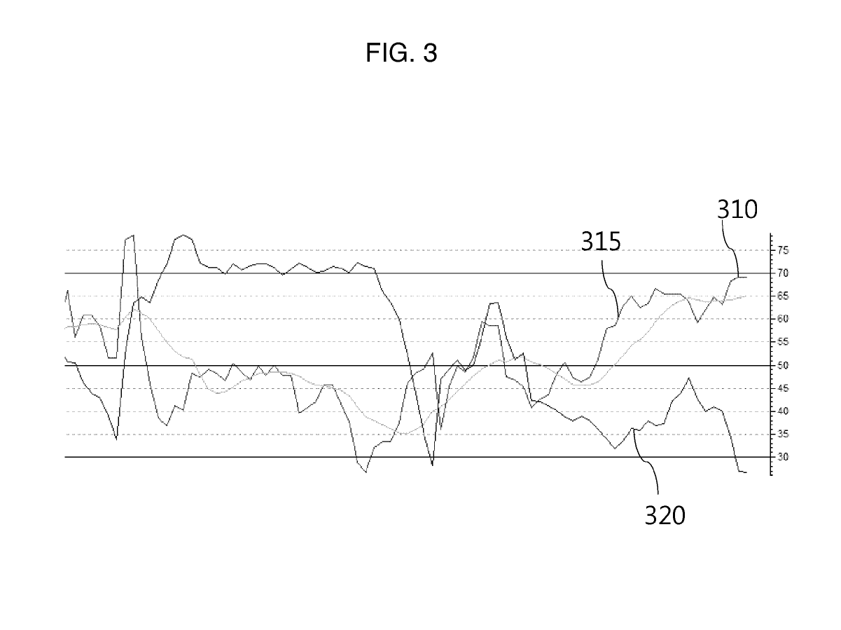

The stock exchange server 130 serves to provide real time stock quote data resulting from dynamic bid and ask price units for respective securities issues to the stock information providing server 120. Here, the stock quote data may include the details of trading resulting from the dynamic bid and ask price units for the respective securities issues.

[The Description of FIG. 2 and FIG. 3]

FIG. 2 is a block diagram schematically illustrating an internal configuration of a stock information providing server according to the embodiment of the present invention, and FIG. 3 is an exemplary view in which stock trading data is displayed in a visual information form according to the embodiment of the present invention.

Referring to FIG. 2, the stock information providing server 120 includes: a communication unit 210; a collection unit 215; a calculation unit 220; an information providing unit 225; a database 230; and a server controlling unit 235.

The communication unit 210 serves to transmit and receive data with other devices (for example, the user terminal 110 and the stock exchange server 130) via a communication network.

The collection unit 215 serves to collect stock quote data in real time in a state of being linked with the stock exchange server 130 via the communication unit 210 and to record the data into the database 230.

As described above, the collected stock quote data may include quote data for respective bid and ask price units and the details of trading.

The calculation unit 220 serves to derive at least one of an aggressive sale quantity, an aggressive purchase quantity and a net aggressive purchase quantity for each dynamic bid and ask price unit by using a current market price, the best ask price, the best bid price and a total trading quantity for each dynamic bid and ask price unit regarding respective securities issues.

Since the method of deriving the aggressive sale quantity, the aggressive purchase quantity and the net aggressive purchase quantity for each dynamic bid and ask price unit is the same as that described above, the repeated descriptions thereof will be omitted.

The information providing unit 225 serves to provide stock trading data including at least one of information on the aggressive sale quantity, the aggressive purchase quantity and the net aggressive purchase quantity for each dynamic bid and ask price unit regarding the respective securities issues derived from the calculation unit 220 to the user terminal 110.

At this time, the information providing unit 225 may process the stock trading data to correspond to visual information to be displayed on the user terminal 110, thereby providing the data.

For example, when providing the stock trading data in a table form, the information providing unit 225 may provide the stock trading data to the user terminal 110 by processing it as shown in Table 2 to Table 4.

For other example, the information providing unit 225 may provide the stock trading data to the user terminal 110 by processing it in a separate chart form as shown in Table 3.

FIG. 3 is a view exemplifying a case in which the user terminal 110 or the stock information providing server 120 displays the stock trading data in a chart form using at least one of information on the aggressive sale quantity, the aggressive purchase quantity and the net aggressive purchase quantity for each dynamic bid and ask price unit derived from using real time stock quote data.

Reference numeral 310 represents a net aggressive purchase quantity, reference numeral 315 represents an open interest, and reference numeral 320 represents a price fluctuation index. Referring to FIG. 3, although the net aggressive purchase quantity is on an upward trend, it can be seen that resistance is strong when the price fluctuation index is delayed or comes down. When such a resistance range is not overcome through a certain increase in trading volume, the danger of a fall is increased. However, when an increase in net aggressive purchase quantity along with an increase in open interest or trading volume are shown, the danger of the fall is reduced upon resistance.

The database 230 stores real time stock quote data for respective securities issues collected through the collection unit 215. Also, the database 230 may further store information on the aggressive sale quantity, the aggressive purchase quantity and the net aggressive purchase quantity for each real time dynamic bid and ask price unit regarding the respective securities issues which are derived through the calculation unit 220.

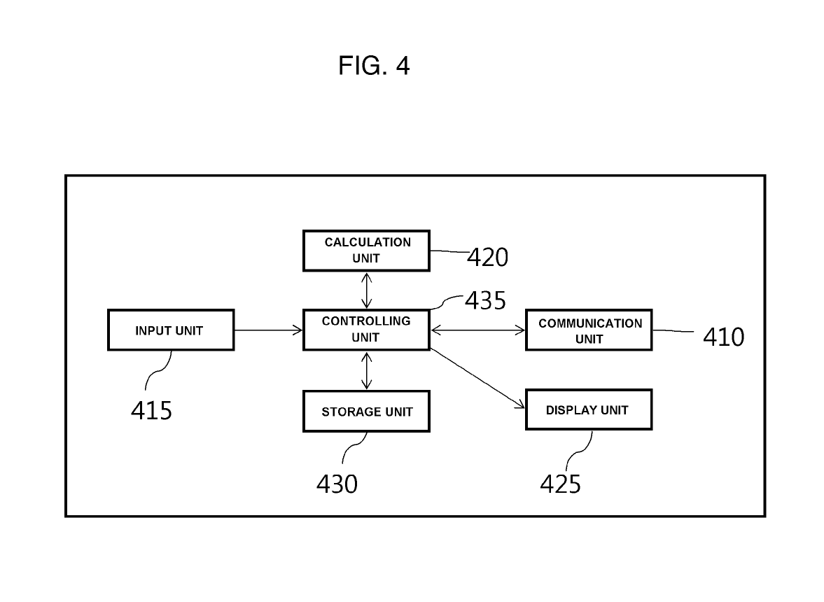

The server controlling unit 235 serves to control internal constitutive elements (e.g., the communication unit 210, the collection unit 215, the calculation unit 220, the information providing unit 225 and the database 230) of the stock information providing server 120 according to the present embodiment of the invention.

[The Description of FIG. 4]

FIG. 4 is a block diagram schematically illustrating an internal configuration of the user terminal according to the embodiment of the present invention.

Referring to FIG. 4, the user terminal 110 includes a communication unit 410, an input unit 415, a calculation unit 420, a display unit 425, a storage unit 430 and a control unit 435.

The communication unit 410 serves to transmit and receive data with other devices via a communication network.

The input unit 415 serves to input a control command for controlling an operation of the user terminal 110, a control command for driving an application, and arbitrary information. For example, the input unit 415 may be implemented in a plurality of key buttons (for example, a figure/word key, a sign key such as * or #, one or more functional keys (e.g., a menu key, a talk key, a confirmation key, an enter key for executing an application and the like)) or the input unit may be implemented in a form such as a touch screen and the like.

The calculation unit 420 serves to receive real time stock quote data provided from the stock information providing server 120 via the communication unit 410, and to calculate an aggressive sale quantity, an aggressive purchase quantity and a net aggressive purchase quantity for each dynamic bid and ask price unit regarding respective securities issues using the data. Since the calculation unit is the same as that described in the description section of FIG. 1, the repeated descriptions thereof will be omitted.

The display unit 425 serves to output information inputted through the input unit 415 due to control of the control unit 435, and data stored in the storage unit 435 in a visual information form. For example, the display unit 425 may be a liquid crystal display (LCD).

The storage unit 430 stores various applications which are needed for operating the user terminal 110 according to the present embodiment of the invention. Of course, the storage unit 430 may temporarily store the real time stock quote data, and information on the aggressive sale quantity, the aggressive purchase quantity and the net aggressive purchase quantity.

In FIG. 4, it is assumed that the user terminal 110 calculates the aggressive sale quantity, the aggressive purchase quantity and the net aggressive purchase quantity for each dynamic bid and ask price unit. However, the user terminal 110 may receive the stock trading data including various kinds of relevant information provided from the stock information providing server 120.

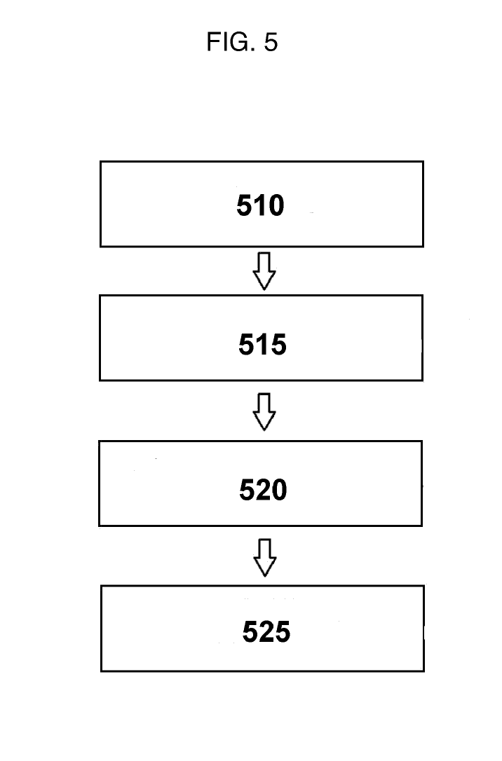

The control unit 435 serves to control internal constitutive elements (e.g., the communication unit 410, the input unit 415, the calculation unit 420, the display unit 425, the storage unit 430 and the like) of the user terminal 110 according to the present embodiment of the invention.

[The Description of FIG. 5]

FIG. 5 is a flowchart showing a method for providing stock information to the user terminal according to another embodiment of the present invention, which is conducted by the stock information providing server. Each of steps which will be described hereinafter is conducted by the respective internal constitutive elements of the stock information providing server 120, but in order to provide the convenience of understanding and description, the constitutive elements will be called the stock information providing server.

In step 510, the stock information providing server 120 is linked with the stock exchange server 130 in real time to collect real time stock quote data.

Here, as previously described, the stock quote data may include quote data and a total trading quantity for each dynamic bid and ask price unit.

In step 515, the stock information providing server 120 calculates at least one of the aggressive sale quantity, the aggressive purchase quantity and the net aggressive purchase quantity for each dynamic bid and ask price unit regarding respective securities issues using the collected stock quote data.

Here, since the method of calculating the aggressive sale quantity, the aggressive purchase quantity and the net aggressive purchase quantity is the same as that previously described, the repeated descriptions thereof will be omitted.

Here, step 510 and step 515 may be repeatedly performed as the stock quote data is updated.

In step 520, the stock information providing server 120 generates stock trading data including at least one of information on the calculated aggressive sale quantity, aggressive purchase quantity, net aggressive purchase quantity, and stock quote data.

In step 525, the stock information providing server 120 converts the generated stock trading data into a predetermined visual information form and transmits it to the user terminal 110.

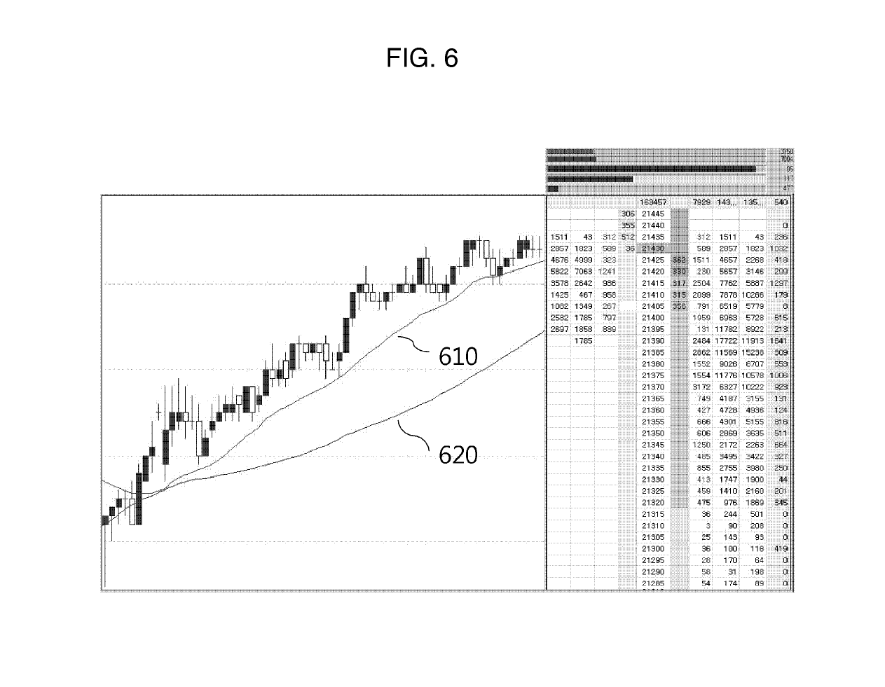

Of course, the stock information providing server 120 may convert the stock trading data to correspond to a display form requested by the user terminal 110, and may transmit the converted data to the user terminal 110.

[The Description of FIG. 6]

FIG. 6 is a view illustrating a monitor on which a price level of a candle chart and a price level for bid and ask price units are displayed in a state of being linked with each other. In FIG. 6, it is assumed that linkage of a price level of a candle chart and a price level of bid and ask units is displayed in a table form. However, it may be displayed in other forms such as a chart form except for the table form.

Reviewing the table in which the price level of the candle chart and the price level of the bid and ask price units are linked with each other, it can be seen that the price level of bid and ask prices listed according to bid and ask units is present on the same line as the price level of the candle chart.

In this specification, the term “on the same line” does not means only the same position as viewed in a horizontal line, but means including at least one of the same height, the same position, the same level, and the same depth.

Reference numeral 610 may represent a 20 moving average and may also be a minute candle, a daily candle, a weekly candle or a monthly candle. At a glance, it can be confirmed that the 20 moving average is present at 241.25 of the bid and ask prices listed to the right. Similarly, reference numeral 620 may represent a 60 moving average, and at a glance, it can be confirmed that the 60 moving average is coincident with 213.95 of the bid and ask prices listed to the right.

Although it is not illustrated in FIG. 6, a moving average and the like in a daily candle and a weekly candle may be indicated separately.

That is, as shown in FIG. 6, users do not need to calculate the price ranges of main moving averages according to a specific period unit, and an aggressive purchase quantity, an aggressive sale quantity and a net aggressive purchase quantity in the price range of a relevant moving average can be confirmed. Furthermore, in the case of a stock provided with open interest, an increase and reduction of the open interest can be confirmed at a glance.

At this time, the chart or table according to the present embodiment of the invention may be displayed in various figures, signs, images and colors. When a stock price reaches a current price in the table, it may be indicated separately as a sound.

Also, since the bid and ask price units may be large depending on setting of the dynamic bid and ask price units, the table may display a detailed price movement in the bid and ask prices separately.

Also, a time unit of the chart may be displayed in a state of being automatically converted into a minute, daily, weekly or monthly chart depending on the dynamic bid and ask price units.

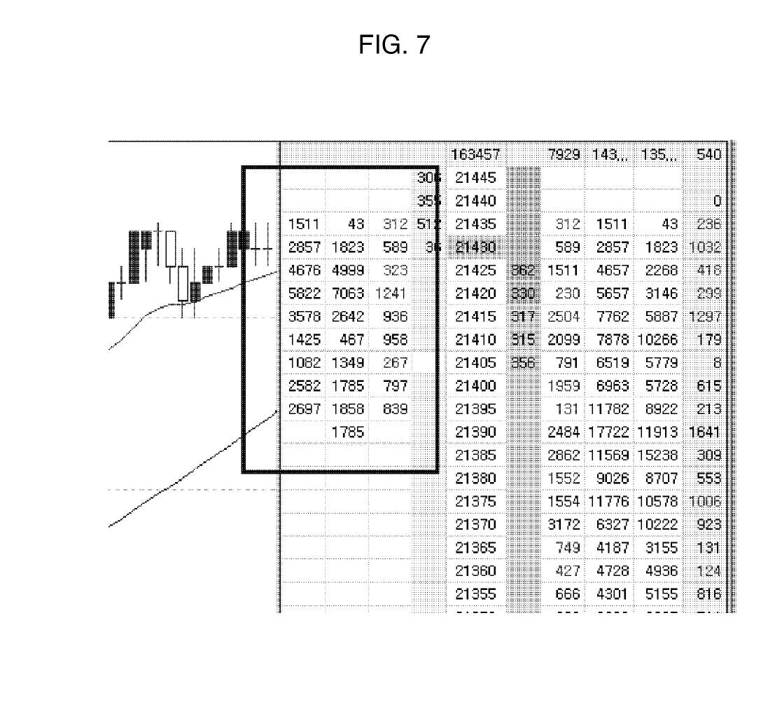

Also, in order to provide the convenience of understanding and description, in FIG. 6, the monitor is illustrated in a two-dimensional chart or table form, but it may also be displayed in a three-dimensional chart or table.

[The Description of FIG. 7]

FIG. 7 is a view showing an example of displaying an aggressive sale quantity and an aggressive purchase quantity at regular intervals according to a still further embodiment of the present invention.

As illustrated in FIG. 7, by excluding aggressive sale and purchase quantities which are 10 ticks lower than a current market price while excluding aggressive sale and purchase quantities which are 10 ticks higher than a current market price, the aggressive sale and purchase quantities may be displayed. Due to this, when a current market price is beyond a specific area, a trading volume which is newly shown can be rapidly recognized. For example, it can be confirmed that the trading volume exceeds a specific area with a large aggressive purchase quantity.

Also, the aggressive sale and purchase quantities may be displayed based on time intervals having a meaning such as of five minutes, ten minutes, thirty minutes and the like based on present time by introducing a time concept.

In this specification, although it is not described separately, when a specific period (date and time) is set, the stock information providing device 120 may provide stock trading data of the relevant specific period and may then replay it in real time.

Meanwhile, the method for providing stock information according to the present embodiment of the invention may be implemented in a program command form that is capable of being conducted through various means for electronically treating information so as to be recorded into a storage medium. The storage medium may include a program command, a data file, and a data structure independently, or a combination thereof.

The program command recorded in the storage medium may be an element which is specifically designed and constituted for the present embodiment of the invention, or may be an element which was publicly known to those having ordinary skill in the art of a software field to be available to the public. Examples of the storage medium are magnetic media such as a hard disk, a floppy disk and a magnetic tape, an optical media such as a CD-ROM and a DVD, a magneto-optical media such as a floptical disk, and a hardware device specifically configured to store and exercise a program command such as a ROM, a RAM, a flash memory and the like. Also, the aforesaid media may be a transmission media such as a beam or a metallic line, a wave guide and the like including a carrier wave which transmits signals to designate a program command, a data structure and the like. Examples of the program command include a machine language code as made by a compiler, and a device for electronically treating information using an interpreter and the like, for example, a high-level language code which may be exercised by a computer.

The aforesaid hardware device may be configured to operate as one or more software modules in order to conduct the operation of the present embodiment of the invention. The converse thereof is the same.

Although the embodiments of the present invention have been disclosed for illustrative purposes, those skilled in the art will appreciate that various modifications, additions and substitutions are possible, without departing from the scope and spirit of the invention as disclosed in the accompanying claims.

1-13. (canceled)

14. A method in which a stock information providing server linked with a stock exchange server via a communication network provides stock information to a user terminal, the method comprising:
(a) the stock information providing server collecting stock quote data for respective securities issues in real time from the stock exchange server;
(b) the stock information providing server calculating an aggressive sale quantity and an aggressive purchase quantity for each bid and ask price of trading conclusions using the real time stock quote data and previous stock quote data by judging a trading volume concluded by a selling order at a highest bid price as the aggressive sale quantity, and a trading volume concluded by a buying order at a highest ask price as the aggressive purchase quantity, and further calculates a difference of the aggressive sale quantity corresponding to the aggressive purchase quantity as a net aggressive purchase quantity, wherein the aggressive sale quantity, the aggressive purchase quantity and the net aggressive purchase quantity are defined as an aggressive trading volume;
(c) the stock information providing server providing stock information including an aggressive trading volume accumulated by adding up the defined real time aggressive trading volume and a previous aggressive trading volume to the user terminal; and
(d) the user terminal controlling the stock information including the accumulated aggressive trading volume to be displayed through a display device.

15. The method according to claim 14, further comprising continuously displaying the accumulated aggressive trading volume to overlap according to the flow of time so that the strength of support and resistance can be confirmed through the aggressive volume.

16. The method according to claim 14, further comprising the user terminal controlling the accumulated aggressive trading volume for each entire bid and ask price to be recalculated and displayed according to a dynamic bid and ask price unit upon receiving a request for a change in the dynamic bid and ask price unit from a user so that history of support and resistance for respective securities issues can be easily understood in a long and short term.

17. The method according to claim 16, wherein the request for the change in the dynamic bid and ask price unit from the user comprises at least one request on a unit of time for the respective securities issues and a bid and price unit.

18. The method according to claim 14, further comprising the user terminal displaying only large/small bid and ask price ranges separately based on a current bid and ask price with regard to the accumulated aggressive trading volume.

19. The method according to claim 16, wherein the user terminal displays the stock trading data in a visual information form using at least one of a stock chart and a table in which the stock trading data is converted by being linked with a unit of time according to the dynamic bid and ask unit.

20. The method according to claim 16, wherein the dynamic bid and asked unit is a multiple of the lowest bid and ask unit.

21. A stock information providing device for providing stock information to a user terminal, the device comprising:
a collection unit linked with a stock exchange server via a communication network to collect real time stock quote data for respective securities issues and record the data in a database;
a calculation unit that calculates an aggressive sale quantity and an aggressive purchase quantity for each bid and ask price of trading conclusions using the real time stock quote data for the respective securities issues and previous stock quote data by judging a trading volume concluded by a selling order at a highest bid price as the aggressive sale quantity, and a trading volume concluded by a buying order at the highest ask price as the aggressive purchase quantity, and further calculates a net aggressive purchase quantity by judging a difference of the aggressive sale quantity corresponding to the aggressive purchase quantity as the net aggressive purchase quantity, wherein the aggressive sale quantity, the aggressive purchase quantity and the net aggressive purchase quantity are defined as an aggressive trading volume, and further calculates an accumulated trading volume by adding up the defined real time aggressive trading volume and a previous aggressive trading volume; and
an information providing unit that converts stock information including the accumulated aggressive trading volume for each entire dynamic bid and ask price regarding the respective securities issues into a visual information form, controls the information to be displayed through a display device, and provides the information so that the accumulated aggressive trading volume is continuously displayed to overlap according to the flow of time, thereby enabling a user to easily understand the history of support and resistance in a long and short term.

22. The device according to claim 21, wherein the calculation unit recalculates the accumulated aggressive trading volume for each entire bid and ask price according to a dynamic bid and ask price unit upon receiving a request for a change in the dynamic bid and ask price unit from a user so that the history of support and resistance for respective securities issues can be easily understood in a long and short term.

23. The device according to claim 21, wherein the calculation unit calculates the dynamic bid and ask price unit using at least one of a unit of time and a bid and ask price unit for the respective securities issues.

24. The device according to claim 22, wherein the calculation unit calculates the dynamic bid and ask price unit as a multiple of the lowest bid and ask price unit of the respective securities issues.

25. The device according to claim 21, wherein the information providing unit controls stock trading data to be displayed in a visual information form using at least one of a stock chart and a table in which the stock trading data is converted by being linked with a unit of time according to the dynamic bid and ask unit.
